(19) United States
(12) Patent Application Publication
(10) Pub. No.: US 2026/0201195 A1
(43) Pub. Date: Jul. 16, 2026

(54) COMPOSITION AND PROCESS FOR COATING CELLULOSIC MATERIALS

(71) Applicant: CENTRO NACIONAL DE PESQUISA EM ENERGIA E MATERIAIS, Campinas (BR)

(72) Inventors: Juliana Da Silva BERNARDES, Campinas (BR); Daiane Batista DA SILVA, Campinas (BR); Bruna Pomim MASSUCATO, Campinas (BR); Rubia Figueredo GOUVEIA, Campinas (BR)

(21) Appl. No.: 19/136,630

(22) PCT Filed: Dec. 6, 2023
(86) PCT No.: PCT/BR2023/050438

§ 371 Date: Jun. 6, 2025

(30) Foreign Application Priority Data
Dec. 6, 2022 (BR) 1020220248893

(51) Int. Cl. C09D 107/02; C09D 101/02

(52) U.S. Cl. CPC C09D 107/02; C09D 101/02

(57) ABSTRACT

The present description relates to compositions for coating cellulosic materials comprising multiple layers, including layers based on cellulose or modified cellulose and layers based on natural rubber latex. The coating composition is intended to provide the base cellulosic material with resistance to oil, grease, water, and water vapor. The coating composition also aims at providing microbial resistance when using cationic nanofibrillated cellulose, and a suitable sensory finish to the final product, with a non-sticky feel.

### DESCRIPTION FIELD

The present description is in the field of coating compositions based on modified cellulose. The present description is also in the field of paper coating materials comprising cellulose or its derivatives.

### STATE OF THE ART

Some examples of cellulosic material coatings are known from the state of the art, in which the coating comprises unmodified cellulose and synthetic polymers in its composition, as disclosed in patent documents JP2021137983A and JP2019177586A. Examples of cellulosic material coatings are also known from the prior art, in which the coating comprises modified cellulose, specifically anionic cellulose, and synthetic polymers in its composition, as disclosed in patent documents JP6414284B2 and WO2014181560. These state of the art coatings have the function of protecting the paper against water vapor or gas.

Patent document CN106930140B discloses a paper coating comprising bacterial cellulose, chitosan, latex, polyvinyl alcohol, soy protein, and a rheology regulator. This coating functions as a protection of the paper against oils.

Patent document CN106930140B discloses a coating for cellulosic materials using at least two polyol or saccharide fatty acid esters with different HLB values (acronym for hydrophilic-lipophilic balance), providing the final coating formulation with resistance to water and oil.

No paper coating compositions comprising only cellulose and modified cellulose and natural rubber latex, combining protection against oils and water vapor, were found in the state of the art.

### BRIEF DESCRIPTION OF THE INVENTION

It is one of the objects of the present description to disclose a coating for cellulosic material, in which the coating is composed of biodegradable raw materials, obtained from renewable and abundant plant sources, which may present antimicrobial activity, being resistant to water vapor, oil, and oxygen permeation and, furthermore, having a sensory finish suitable for handling, with a non-sticky feel.

The objects of the present description are achieved by a composition for coating cellulosic materials comprising at least a first layer of cationic nanofibrillated cellulose or microfibrillated cellulose and at least a second layer of natural rubber latex.

The objects of the present description are also achieved by a process for coating cellulosic materials comprising: evenly depositing on the surface of the cellulosic material 30 to 300 mL/m² of an aqueous suspension of cationic microfibrillated or nanofibrillated cellulose of 0.1 to 2.5% by mass; drying under ambient conditions; then, evenly depositing on the surface of the cellulosic material 30 to 300 mL/m² of an aqueous suspension of natural rubber latex of 2.5 to 60% by mass; and drying under ambient conditions.

### BRIEF DESCRIPTION OF THE DRAWINGS

This description is illustrated in the embodiments represented in the figures, as briefly discussed below.

FIG. 1 is a photograph of an oil and grease absorption test on an uncoated kraft paperboard sample as control and four additional kraft paperboard samples coated in accordance with some embodiments of the present disclosure.

FIGS. 2 and 3 are graphs of water vapor mass loss over time, depicting permeability results of coated or uncoated kraft paperboard, according to some embodiments of the present description.

FIG. 4 is a backscattered electron micrograph obtained by scanning electron microscopy (SEM) of a kraft paperboard coated in accordance with one embodiment of the present disclosure.

### DETAILED DESCRIPTION OF THE INVENTION

The present description relates to a composition and a process for coating cellulosic materials comprising a dispersion of cationic microfibrillated or nanofibrillated cellulose and a natural rubber latex dispersion.

In one embodiment of the present description, the cellulosic material receiving the coating is selected from the group comprising cardboard, paperboard, kraft paperboard, white paper, acid paper, alkaline paper, rice paper, hemp paper, vegetable paper, and mixtures thereof.

In one embodiment of the present description, the cellulose of the coating composition derives from one or more plant species selected from the group comprising species of the genus Eucalyptus and the genus Pinus. In another embodiment, cellulose derives from residual biomass from the industry, such as biomass from sugarcane bagasse.

In one embodiment of the present disclosure, the cellulose of the coating composition is used without chemical modification, e.g., commercial microfibrillated cellulose.

In one embodiment of the present disclosure, the cellulose of the coating composition is modified by reaction with 2,3-epoxypropyl trimethyl ammonium chloride (C₆H₁₄NOCl, known by the acronym EPTMAC).

In one embodiment of the present description, the natural rubber latex derives from a natural source, preferably from the Hevea brasiliensis species, whose composition comprises an aqueous dispersion, generally consisting of about 50% to 60% water, about 38% to 48% polyisoprene (mostly cis-1,4-polyisoprene), in addition to other components in smaller quantities, such as proteins, fatty acids, resins, and inorganic salts.

In one embodiment of the present description, the coating comprises at least a first layer of cationic microfibrillated or nanofibrillated cellulose, in contact with the base cellulosic material, and at least a second layer of natural rubber latex. In one embodiment of the present description, the coating comprises a third layer of cationic microfibrillated or nanofibrillated cellulose. In one embodiment of the present description, the coating comprises a fourth layer of natural rubber latex. In one embodiment of the present description, the coating comprises a fifth layer of cationic microfibrillated or nanofibrillated cellulose. In one embodiment of the present description, the coating may comprise up to nine alternating layers.

In any embodiment of the present description, the cationic microfibrillated or nanofibrillated cellulose layer presents a better interaction with the base cellulosic material, being preferably provided as the first layer of the coating. The latex layer, in turn, has good interaction with the cellulose layer, resulting in good adhesion between these coating layers.

The cationic nanofibrillated cellulose has antimicrobial properties known from the state of the art. Otoni and collaborators (Appl. Bio Mater. 2019, 2, 5, 1975-1986) produced cationic nanocellulose foams with activity against Escherichia coli. In turn, Littunen and collaborators (European Polymer Journal, 2016, 75, 116-124) evaluated the antimicrobial capacity of two types of cationic nanocellulose against the M. luteus, E. coli bacteria and a C. oleophila yeast, obtaining up to 93% inhibition of the Gram negative and 98% of the yeast.

The natural rubber latex layer has a sticky consistency finish, so it is preferable that the outermost layer of the final product be a layer of cationic microfibrillated or nanofibrillated cellulose, which has a more suitable sensory finish.

The present description further includes a process for coating cellulosic materials, which includes the steps of:
evenly depositing on the surface of cellulosic material 30 to 300 mL/m² of an aqueous suspension of cationic microfibrillated or nanofibrillated cellulose of 0.1 to 2.5% by mass, and drying under ambient conditions; then,
evenly depositing on the surface of the cellulosic material 30 to 300 mL/m² of an aqueous suspension of natural rubber latex of 2.5 to 60% by mass; and drying under ambient conditions.

In one embodiment of the present description, the steps of the above process are successively repeated in order to form new coating layers, interspersing layers of cationic microfibrillated and nanofibrillated cellulose and natural rubber latex.

In any embodiment of the present description, each layer of natural rubber latex has a mass per area 30 to 100 times greater than the mass per area of each layer of cationic nanofibrillated cellulose.

Exemplary realizations of the object described herein are presented below, in a non-restrictive manner, illustrating results and advantages achieved thereby.

### Example 1—Cationization Process of Cellulose Pulp

In this exemplary embodiment, a mass of 10 g of freeze-dried cellulose pulp derived from sugarcane bagasse was added to 0.050 mol of homogenized NaOH, and heated to 65° C. Then, 0.2775 mol of 2,3-epoxypropyl trimethyl ammonium chloride (EPTMAC) was added to the cellulose mass, which was kept in an ultrasonic bath at 65° C. and manually homogenized every 30 min for 4 h. After the reaction, samples of the intermediate product were purified by successive cycles of washing, centrifugation, and removal of the supernatant against 95% v/v ethyl alcohol (3 times), 0.02 mol/L HCl (2 times), and ultrapure water (1 time). They were then dialyzed against distilled water. After purification, the product underwent a microfluidization process, resulting in a final product that is a suspension of cationic nanofibrillated cellulose.

### Example 2—Implementation of the Coating Process

In an exemplary embodiment of the coating process described herein, the natural rubber latex is a suspension of about 50% by mass. The cationic nanofibrillated cellulose is a suspension diluted to 0.5% by mass, obtained according to the process of EXAMPLE 1. The base cellulosic material is a 240 g/m² sheet of kraft paperboard.

To form the nanofibrillated cellulose layers of the coating, 5.5 ml of the suspension were deposited in a straight line (about 12 cm) with the aid of a pipette. Then, an extender was used in order to evenly spread the suspension across the paper. The bar height used was 200 μm. The film was allowed to dry at room temperature.

To form the latex layers of the coating, 4 mL of the suspension were deposited in a straight line (about 12 cm) with the aid of a pipette. Then, an extender was used in order to evenly spread the suspension across the paper. The bar height used was 100 μm. The film was allowed to dry at room temperature.

### Example 3—Oil and Grease Absorption Test

The oil and grease absorption test was based on the TAPPI 559 pm-96 standard described in Anne Riekki's master's thesis, “Oil and Grease Resistant Paperboard-Factors Affecting Barrier Properties and an Evaluation of the Test Methods”, presented in 2019 at the University of Tampere (Finland). A set of 12 reagent kits for oil and grease absorption test were prepared from the proportions described in Table 1.

TABLE 1
Proportion of reagents for making oil
and grease absorption test kits.

| Kit # | Castor oil (mL) | Toluene (mL) | N-heptane (mL) |
|---|---|---|---|
| 1 | 100 | 0 | 0 |
| 2 | 90 | 5 | 5 |
| 3 | 80 | 10 | 10 |
| 4 | 70 | 15 | 15 |
| 5 | 60 | 20 | 20 |
| 6 | 50 | 25 | 25 |
| 7 | 40 | 30 | 30 |
| 8 | 30 | 35 | 35 |
| 9 | 20 | 40 | 40 |
| 10 | 10 | 45 | 45 |
| 11 | 0 | 50 | 50 |
| 12 | 0 | 45 | 55 |

For the oil and grease absorption test, samples of kraft paperboard coated with different combinations of layers were prepared, according to the coating process of EXAMPLE 2, as well as, an uncoated kraft paperboard. Table 2 lists acronyms for the kraft paperboard samples with different combinations of cationic nanofibrillated cellulose (CNFC) layers and natural rubber latex (NRL) layers, which were evaluated for their barrier properties in the oil and grease absorption test of this example.

TABLE 2
Samples of kraft paperboard coated
with different layer combinations.

| | | 1st | 2nd | 3rd | 4th | 5th |
|---|---|---|---|---|---|---|
| Sample | Paper | Layer | Layer | Layer | Layer | Layer |
| Control | Kraft | — | — | — | — | — |
| 1 layer | Kraft | NRL | — | — | — | — |
| 2 layers | Kraft | NRL | NRL | — | — | — |
| 3 layers | Kraft | CNFC | NRL | CNFC | — | — |
| 5 layers | Kraft | CNFC | NRL | CNFC | NRL | CNFC |

The oil and grease permeation test consists of depositing a drop of a kit reagent from Table 1 on the kraft paperboard sample, keeping the reagent on the sample for 15 s, and then removing the excess with a paper towel. The tests started with kit #6. If the paper sample absorbs the drop of the kit reagent (wherein absorption is identified by the darkening of the paper), the next kit to be tested is the one with the lower number. In turn, if the paper does not absorb the drop of the kit reagent, the next kit to be tested is the one with the higher number. This procedure is repeated until the highest numbered kit that is not absorbed is identified for each paper sample. This test was performed in triplicate and the result is the average of the kit numbers defined in the test.

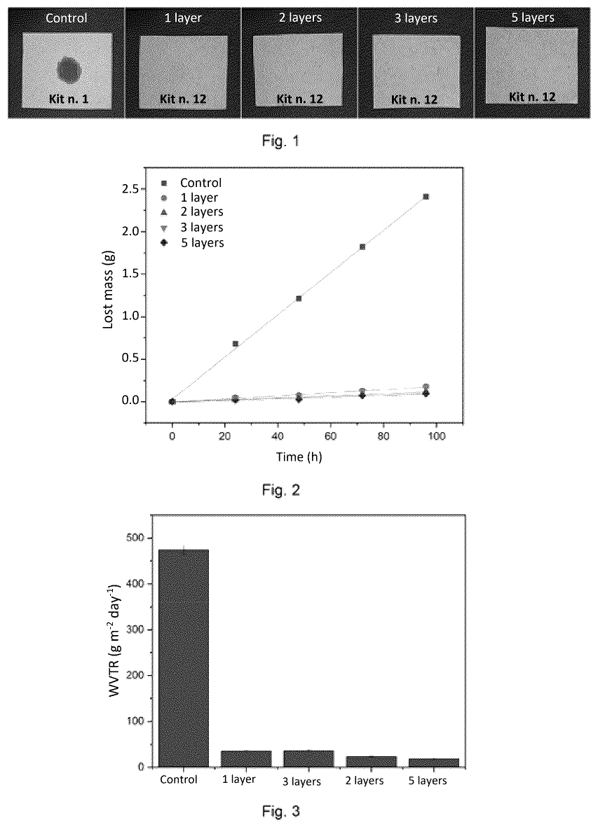

FIG. 1 shows the results of the oil and grease permeation test of this example, for a sample of: only kraft paperboard (Control), which showed permeation of kit #1; kraft paperboard with a layer of natural rubber latex (1 layer) that presented permeation of kit #12; kraft paperboard with two layers of natural rubber latex (2 layers), which presented permeation of kit #12; kraft paperboard with three alternating layers of cationic nanofibrillated cellulose and natural rubber latex (3 layers), which presented permeation of kit #12; and kraft paperboard with five alternating layers of cationic nanofibrillated cellulose and natural rubber latex (5 layers), which presented permeation of kit #12.

### Example 3—Water Vapor Permeability Test

This test was adapted from the ASTM E96 standard. The test was carried out by using paper samples, as detailed in Table 2, previously cut into a circular shape and fixed to the upper opening of a plastic container containing 7 mL of distilled water. The container was sealed using silicone grease and the paper was secured with snap fasteners. The paper side containing the coating was placed facing the inside of the container, to regulate the passage of water vapor from the inside to the outside of the container.

Each assembly, comprising container, water, paper sample, and snap fasteners, was weighed and then placed in a humidity-controlled environment. Temperature and humidity were monitored using a thermo-hygrometer and the assemblies with different paper samples were weighed at specific times in order to verify water loss as a function of time.

FIGS. 2 and 3 present the results of water loss as a function of time for different paper samples, coated or uncoated.

Table 3 presents the average results of the oil and grease permeability tests of example 2, and the water vapor permeability tests for each paper sample.

TABLE 3
Summary of the permeability test results

| | Water vapor permeability | |
|---|---|---|
| Sample | rate (g/day · m²) | Oil and grease test # |
| Control | 474 ± 9 | 1 |
| 1 layer | 35 ± 2 | 12 |
| 2 layers | 23 ± 2 | 12 |
| 3 layers | 36 ± 3 | 12 |
| 5 layers | 19 ± 3 | 12 |

From the results presented in FIGS. 2 and 3 and table 3, it follows that the samples containing layers of natural rubber latex have the capacity to act as a barrier to oil and grease, as well as to water vapor, the results of the combination of latex layers and cationized cellulose being equal or better when compared to samples without cellulose. Preliminary results using unmodified microfibrillated cellulose demonstrated similar barrier properties.

When interpreting the above results, it is worth highlighting that each NRL layer in these examples has a mass approximately 70× greater than each CNFC layer. Therefore, multiple layers of latex are expected to constitute an important physical barrier in permeation tests. On the other hand, the advantageous results obtained from the interaction between NRL and CNFC layers are surprising, since the CNFC layers have relatively low mass.

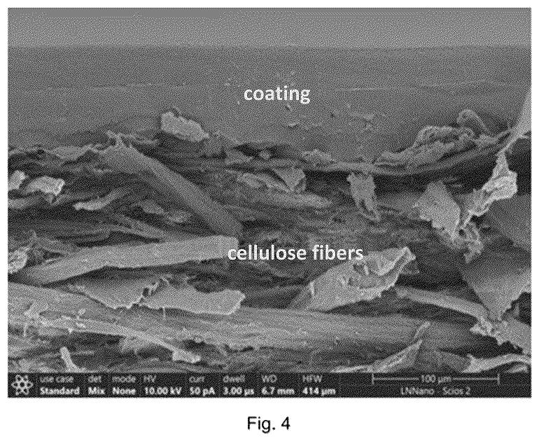

FIG. 4 is a backscattered electron micrograph obtained by scanning electron microscopy (SEM) of a kraft paperboard coated in accordance with one embodiment of the present disclosure. In the image, it is possible to see the cellulose fibers of the kraft paperboard, coated by a smooth layer composed of latex and nanocellulose.

Other advantages that become evident from the object described here, based on embodiments thereof, include the compatibility of the layers with each other, as well as between the CNFC layer and the cellulosic substrate, the use of biodegradable raw materials to make the coating, which are obtained from renewable and abundant plant sources, the antimicrobial activity of the CNFC, and furthermore presenting a sensory finish suitable for handling the final product, with a non-sticky feel.

Although exemplary embodiments of the described processes and products have been presented in this specification, the scope of protection is not intended to be limited to the literal meaning thereof. Therefore, the description should be interpreted not as limiting, but merely as examples of particular embodiments that retain the inventive concept presented here. A skilled person may readily apply the teachings presented herein to analogous solutions arising therefrom, limited only by the scope of the claims of this application.

1. A composition for coating cellulosic materials, comprising a first layer comprising cationic microfibrillated or nanofibrillated cellulose and a second layer comprising natural rubber latex.

2. The composition according to claim 1, further comprising a third layer comprising cationic microfibrillated or nanofibrillated cellulose.

3. The composition according to claim 2, further comprising a fourth layer comprising natural rubber latex.

4. The composition according to claim 3, further comprising a fifth layer comprising cationic microfibrillated or nanofibrillated cellulose.

5. The composition according to claim 4, wherein the composition includes up to nine alternating layers of cationic microfibrillated or nanofibrillated cellulose and natural rubber latex.

6. The composition according to claim 1, wherein the second layer of natural rubber latex has a mass per area 30 to 100 times greater than a mass per area of first layer of cationic microfibrillated or nanofibrillated cellulose.

7. The composition according to claim 1, wherein the cellulose of the first layer derives from one or more plant species selected from the group consisting of species of the genus Eucalyptus and species of the genus Pinus.

8. The composition according to claim 1, wherein the cellulose of the first layer derives from industrial waste biomass.

9. The composition according to claim 1, wherein the cellulose of the first layer is modified by reaction with 2,3-epoxypropyl trimethyl ammonium chloride.

10. A process for coating cellulosic materials comprising:
evenly depositing on the surface of cellulosic material 30 to 300 mL/m² of an aqueous suspension of cationic microfibrillated or nanofibrillated cellulose of 0.1 to 2.5% by mass;
drying the aqueous suspension of cationic microfibrillated or nanofibrillated cellulose under ambient conditions;
evenly depositing on the surface of the cellulosic material 30 to 300 mL/m² of an aqueous suspension of natural rubber latex of 2.5 to 60% by mass; and
drying the aqueous suspension of natural rubber latex under ambient conditions.

11. The process according to claim 10, further comprising successively repeating the steps of suspension deposition and drying to form new coating layers.

12. The composition according to claim 8, wherein the industrial waste biomass comprises sugarcane bagasse.
